(19) United States
(12) Patent Application Publication
(10) Pub. No.: US 2005/0095183 A1
(43) Pub. Date: May 5, 2005

(54) Process and apparatus for biomass gasification

(75) Inventors: Amirale G. Rehmat, Darien, IL (US); Richard L. Kao, Northbrook, IL (US)

Correspondence Address: PLEVY & HOWARD, P.C., P.O. BOX 226, FORT WASHINGTON, PA, 19034, US

(73) Assignee: Biomass Energy Solutions, Inc.

(21) Appl. No.: 10/980,714

(22) Filed: Nov. 3, 2004

Related U.S. Application Data
(60) Provisional application No. 60/517,749, filed on Nov. 5, 2003.

(51) Int. Cl. B01J 8/04

(52) U.S. Cl. 422/188

(57) ABSTRACT

A waste-to-synthesis gas system including: a first gasifier for receiving biomass; a gas distributor for delivering reactant gas and oxygen into the first gasifier in a countercurrent direction to the biomass flow and to define a plurality of reaction regions including a drying region, a pyrolysis region, a gasification region and a combustion region; and, a second gasifier for receiving gases from the plurality of regions of the first gasifier and a gas distributor for delivering reactant gas and oxygen into the second gasifier in a concurrent direction to the flow of gases from the first gasifier. As a result, no carbon chars, oils or tars are expected to be present in the synthesis gas produced.

### RELATED APPLICATIONS

This application claims priority of U.S. Patent Application Ser. No. 60/517,749, filed Nov. 5, 2003 and entitled SLUDGE ELIMINATION SYSTEM AND METHOD, the entire disclosure of which is hereby incorporated by reference herein as if being set forth in its entirety.

### FIELD OF THE INVENTION

This invention relates to the field of biomass gasification and, more particularly, to a device and process for the conversion of biomass to a working synthesis gas source.

### BACKGROUND OF THE INVENTION

As the world's energy shortage has raised the price of energy from fossil fuels to record highs, there is an increasing interest in the conversion of renewable biomass into usable products for fuel production.

Biomass typically comprises collectable, plant-derived materials that may be readily abundant and relevantly inexpensive in comparison to fossil fuels. Additionally, biomass may be potentially convertible to feedstock chemicals or used for electricity generation. Some examples of sources of biomass may be, without limitation, wood, grass, agriculture and farm wastes, manure, waste paper, rice straw or rice husks, corn stores, corn cobs, sorghum stover, poultry litter, sugarcane bagasse, waste resulting from vegetable oil extraction, peanut shells, coconut shells, shredded bark, food waste, urban refuse and municipal solid waste.

There are three main components to biomass: cellulose, hemicellulose and lignin. For example, a typical composition of dry wood is 42% cellulose, 38% hemicellulose and 20% lignin. Cellulose contains long, unbranched chains of glucose units, having the general formula (C₆H₁₀O₅)ₙ, and is typically the main constituent of biomass tissue. In fact, the pure cellulose fraction of essentially all plant tissues is basically the same, consisting of long polymer chains of glucose. It rarely occurs in nature in its pure stage, but is generally found intimately mixed with compounds, such as lignin, pentosans, gums, tannin, fats, coloring matter, and the like. Differences in the properties of cellulose may be due primarily to different degrees of polymerization. For example, it is suspected that bagasse and rice husk cellulose have a polymer chain of about 2,000-3,000 units, while wood has about 10,000 units per chain. Lignin, the other principal constituent of biomass fibers, is the name given to a group of high molecular weight substances, which may be generally associated with cellulose and hemicellulose. Its chemical structure is largely aromatic and is composed of benzene rings, which contain some free and some methylated phenolic groups.

Burning the world's quickly diminishing fossil fuels, such as coal, oil, natural gas and gasoline, returns to the environment carbon that has been locked within the earth for millions of years, and creates a carbon imbalance at the earth's surface. On the other hand, the use of biomass as a fuel source would help maintain a more balanced state in the natural carbon cycle at the earth's surface, since the gasification or combustion of renewable biomass puts the same amount of carbon back into the environment that occurs naturally through plant decay.

As can be seen in Table 1, almost all biomass, regardless of its source, contains about 40% oxygen on a moisture-free basis, while fossil fuel sources, such as bituminous coal, have less than 10% oxygen. Bituminous coal has been included in Table 1 for comparison purposes.

The DuLong relationship between the heat of combustion (high heating value) and the elemental composition as given in the ultimate analysis may be represented by:
HHV, Btu/lb=145.44C+620.28H+40.50S −77.54 O. (1)

TABLE 1
BIOMASS COMPOSITIONS (AS RECEIVED)

| | Crop | | | | | | | |
|---|---|---|---|---|---|---|---|---|
| | Residue | | | | | | | |
| | (corn | | | | | | | |
| | stoves, | | | | | | | |
| | wheat | Sugarcane | Beech | Sudan | Recycle | Yard | Food | Bituminous |
| | straw, etc.) | Bagasse | Wood | Grass | Paper | Waste | Waste | Coal |
| | wt % (moisture free) | | | | | | | |
| C | 43.65 | 44.80 | 50.4 | 44.58 | 44.0 | 48.0 | 50.0 | 78.0 |
| H | 5.56 | 5.35 | 7.2 | 5.35 | 6.0 | 6.0 | 6.0 | 5.1 |
| N | 0.61 | 0.38 | 0.3 | 1.21 | 0.3 | 3.0 | 3.0 | 1.4 |
| O | 43.31 | 39.55 | 41.0 | 39.18 | 44.0 | 38.0 | 38.0 | 6.3 |
| S | 0 | 0.01 | 0 | 0.01 | 0.2 | 0.3 | 0.4 | 1.5 |
| Ash | 5.58 | 11.27 | 1.0 | 8.65 | 5.5 | 4.7 | 2.6 | 7.7 |
| Total | 100.00 | 100.00 | 100.0 | 100.00 | 100.0 | 100.0 | 100.0 | 100.0 |
| Typical | 30 | 49 | 19 | 30 | 17 | 30 | 50 | 7.2 |
| Moisture, | | | | | | | | |
| Wt % | | | | | | | | |

This difference is significant, because the higher level of oxygen contained in biomass gives it a lower heating value as shown by the Dulong relationship. For example, the heating value for biomass may typically be about 6,500 Btu/lb to about 8,500 Btu/lb on a dry basis, as compared with about 14,080 Btu/lb on a dry basis for bituminous coal. Furthermore, the large moisture content of biomass means that more energy may be required to preheat and vaporize the water content. For instance, a sugarcane bagasse (the fibrous residue of the cane stalk after crushing and extraction of the juice), which consists of water, fibers and relatively small quantities of soluble solids, contains about 49% moisture, and has a heating value of only about 3,864 Btu/lb. In other words, more biomass (possibly two to three times) may have to be processed through a gasifier or combustor in order to produce the same amount of energy as compared to bituminous coal, oil or natural gas.

Efforts have been directed at the following areas to improve the weakness of biomass gasification: increasing the throughput to gain the economics of scale; increasing the operating pressure to reduce the costs of compressing the large volume of gaseous products; and extending the range of compatible feedstocks such as municipal solid waste, used tires, waste oils, etc.

There are several different types of biomass gasifiers currently in existence, and there are various ways to classify them. For example, there are air/oxygen-blown autothermal systems, indirect/direct-contact heating moving bed gasifiers, fluidized/entrained/circulating/bubbling beds, and downdraft/updraft gasifiers.

Previous attempts to create such gasifiers have left the industry with unsolved problems. For example, because of rapid motion and agitation of the feedstock particles in the bed, and the short residence time of the gases, the fluid bed represents a single equilibrium stage similar to a backmix reactor. There is no countercurrent flow and/or heat exchange in the fluid bed. Similarly, in entrained-bed gasifiers, reactants are all introduced into the reaction zone at a common point and flow concurrently. No opportunity is afforded for heat exchange and the product gases exit at full gasification reaction temperature. Furthermore, the above fluidized-bed systems are generally complex due to the requirement of a delicate balance between the two main components, namely the gasification zone and the combustion zone. They are also less receptive to turndown, due to minimum gas requirements to maintain the fluidization status. Additionally, heat transfer is cumbersome and inefficient, due to complex solids circulation. Most troublesome of all are the restrictions for the type, combination and size of biomass to be fed, as well as the maintenance of biomass in the fluid state. Downdraft gasifiers also have poor biomass utilization. Tar formation is typically only controlled through intermittent air injection, with the end result ultimately being the wasting oils, tars and char produced in the gasification process.

For example, as seen in U.S. Pat. No. 3,853,498 and U.S. Pat. No. 4,032,305, the entire disclosures of which are hereby incorporated by reference herein, a process involving separate gasification and combustion zones is described. Both zones in each of these patents are conventional fluidized beds, with the transfer of heat between the beds achieved by the circulation of sand.

U.S. Pat. No. 4,828,581, the entire disclosure of which is hereby incorporated by reference herein, describes a combination of two fluidized beds, one of which heats up a bed of sand by burning char for circulating the heated sand into the second bed, to which biomass is fed. Thus, the heat for biomass gasification is supplied by hot sand. This system requires a delicate heat balance between the two fluidized beds, and results in the product gas containing large quantities of heavy hydrocarbons, such as tar, which requires further treatment to convert into hydrogen. Such a system is susceptible to erosion of the piping within the system by the circulating sand, which is used to transfer heat within the gasifier system.

U.S. Pat. No. 5,937,652, the entire disclosure of which is hereby incorporated by reference herein, describes a process in which carbon dioxide from a boiler flue gas stream is separated, recycled and utilized for gasification of biomass, increasing fuel utilization and decreasing carbon dioxide emissions into the atmosphere.

U.S. Pat. No. 6,048,374, the entire disclosure of which is hereby incorporated by reference herein, utilizes two-step method in which biomass char is combusted in the annulus of a reaction tube to transfer heat from combustion to the biomass indirectly. This method of indirect heating is useful for generating liquids, rather than gases, from the biomass.

U.S. Pat. No. 6,133,328, the entire disclosure of which is hereby incorporated by reference herein, describes a method to produce water gas. The dry biomass is first burnt with heated air to form an incandescent carbon. The heated air is then turned off and steam is added to the steam blanketed incandescent carbon, creating a water gas that contains hydrogen and carbon monoxide.

U.S. Pat. No. 6,613,111, the entire disclosure of which is hereby incorporated by reference herein, describes a small-scale, high-throughput biomass fluidized bed gasifier concentrically housed completely within a fluidized bed combustor, which heats up a bed of sand by burning char and product gas transferred from the gasifier. Heat from the combustor is then transferred to the gasifier by circulation of the hot sand.

U.S. Pat. No. 6,637,206, the entire disclosure of which is hereby incorporated by reference herein, describes a steam boiler/combustor and gasifier system, in which the combustor burns dirty fuels and produces heat and exhaust. The steam boiler receives the heat and product steam for power generation. The gasifier receives the exhaust and biomass, and produces synthesis gas for additional power generation.

U.S. Patent Application No. 20020174811, the entire disclosure of which is hereby incorporated by reference herein, describes a traveling conveyor to transfer biomass along with a controlled quantity of air. Since the biomass is stagnant, the gas-solid contact is limited, thus impairing the biomass conversion efficiency.

U.S. Patent Application No. 20020069798, the entire disclosure of which is hereby incorporated by reference herein, describes a downdraft biomass gasifier in which biomass is progressively reacted with air to produce synthesis gas with minimal quantities of heavy hydrocarbons and tars. In this reactor, char produced during initial reactions is wasted.

U.S. Patent Application No. 20040009378, the entire disclosure of which is hereby incorporated by reference herein, describes the gasification of a lignocellulose type of biomass to produce a fuel gas for fuel cells. The exothermic heat generated in the fuel cells is transferred to the gasifier.

Notwithstanding these approaches, an efficient biomass gasification system providing a balance between endothermic and exothermic gasification reactions is desirable for the production of a clean, particulate-free synthesis gas.

### SUMMARY OF THE INVENTION

A waste-to-fuel system including: a first gasifier for receiving biomass; a gas distributor for delivering reactant gas and oxygen into the first gasifier in a countercurrent direction to the biomass flow and to define a plurality of reaction regions including a drying region, a pyrolisis region, a gasification region and a combustion region; and, a second gasifier for receiving gases from the plurality of regions of the first gasifier and extracting carbon chars, oils and tars therefrom.

### BRIEF DESCRIPTION OF THE DRAWINGS

Understanding of the present invention will be facilitated by consideration of the following detailed description of the preferred embodiments of the present invention taken in conjunction with the accompanying drawings, in which like numerals refer to like parts:

FIG. 1 illustrates a diagrammatic view of an exemplary two-stage gasifier according to an aspect of the present invention;

FIG. 2 illustrates a system incorporating the gasifier of FIG. 1 according to an aspect of the present invention;

FIG. 3 illustrates an exemplary gas distributor suitable for use with the gassifier of FIG. 1; and,

FIG. 4 illustrates is a perspective view of an exemplary embodiment of the present invention showing partial sections of options for gas distribution within each zone of a first-stage gasifier and a second-stage gasifier.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in typical gasifier systems and gasification methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein.

According to an aspect of the present invention, a multi-stage gasifier that overcomes the problems found in the prior art and provides flexibility to convert biomass into synthesis gas which may be subsequently used to generate electric power, steam and/or hydrogen is provided. The gasifier may also serve to substantially simultaneously stabilize non-combustible solid residue generated from biomass gasification.

A gasifier according to an aspect of the present invention is well suited for gasifying different types of biomass, irrespective of ash content. Such a gasifier may convert biomass into liquid and/or gaseous fuel for use by, for example, an engine or fuel cell. Such fuel may be used for a variety of applications, such as for generating power, manufacturing chemicals and providing transportable fuels.

According to an aspect of the present invention, different types of biomass may be introduced substantially irrespective of size, shape or consistency. Different types of biomass may also be mixed in combination and subsequently fed to the gasifier. Additionally, different sorts of carbonaceous material, either individually or in combination, may be fed to the gasifier. According to an aspect of the present invention, a gasifier may be designed for various levels of biomass throughput, be it small or large. For example, it may not be necessary to size or reduce the feedstock as long as it may be introduced into a rotary kiln. This may be particularly useful for backup-feed biomass feedstocks, which may be difficult to size.

According to an aspect of the present invention, as a gasifier according to an aspect of the present invention may allow for operation with all sorts of biomass, either as single feed or in combination. Thus, the certainty for a supply of raw feedstock may be better assured for sustainable operation and continuous distributed power generation.

According to an aspect of the present invention, a gasifier may operate with a variety of gasses, such as air, enriched air, oxygen, mixtures of oxygen with steam and carbon dioxide, for example. The composition and amount of these gases may be varied throughout a two-stage gasifier to obtain improved biomass conversion efficiency as compared to conventional approaches.

According to an aspect of the present invention, a gasifier may be provided with a section in which gas residence time and temperature can be controlled independently for cracking oils and tars. Further, according to an aspect of the present invention, oils and tars may be substantially eliminated by autothermal reforming. Thus, through the control of reaction zone temperatures, biomass conversion may be increased, while oil and tar formation may be reduced during the production of synthesis gas.

According to an aspect of the present invention, gasification under oxygen-starved conditions may be used to produce negligible amounts of undesirable byproducts, such as NOₓ. Gasification under oxygen deficient conditions also inhibits the formation of undesirable byproducts, such as highly toxic dioxins and furans which can be formed when chlorine is present and there is a surplus of oxygen. Particulate emission problems may also be negligible due to the low off-gas flow rate exiting a two-stage gasifier of the present invention.

According to an aspect of the present invention, by distributing gas and oxidant in varying proportions throughout the gasifier, the operating temperature may be varied as needed for improved biomass gasification reactions with the reactant gases. Also, the gasifier may use a limited amount of oxidant, which may increase the heating value of the fuel gas, while minimizing any cooling and scrubbing requirements. Further to this, as the gasifier may generate its own heat, the complexities and limitations of heat transfer may be simplified or even nonexistent.

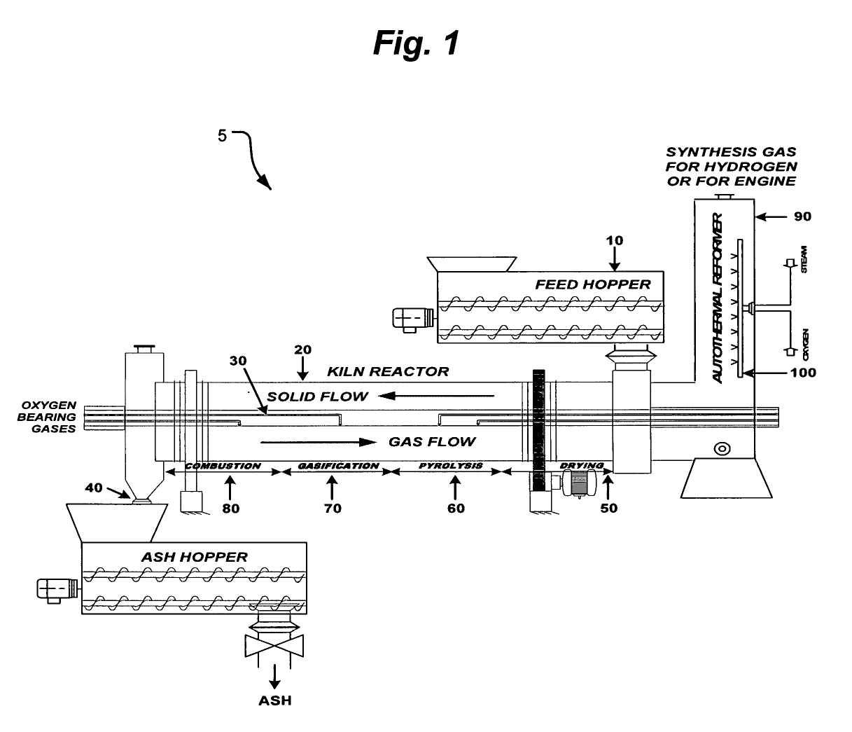

Referring now to FIG. 1, there is shown an exemplary embodiment of a two-stage gasifier system 5 according to an aspect of the present invention. This system may include, but is not limited to, a first-stage gasifier 20, which may include a rotary kiln reactor, and a second-stage gasifier 90, which may include a tubular stationary autothermal reformer. Other features and components of this exemplary embodiment is described in fuller detail.

As will be understood by those possessing an ordinary skill in the pertinent arts, where a rotary kiln is used as the first-stage gasifier, the turndown flexibility of the gasifier may be substantial. This may be particularly advantageous for environments where there may be varying, such as peak and off-peak, power demands. This flexibility may also allow a two-stage gasifier, for example in a rural area, to produce more electricity during peak periods to earn higher rates and to slow down during off-peak times.

Also, because both a kiln and autothermal reformer are well understood in the pertinent arts, a two-stage gasifier according to an aspect of the present invention may have low maintenance requirements, as well as little downtime. It may also be well suited for turnkey systems—as the design is simple and flexible, and may be packaged for distributed power generation. Such turnkey modular systems may range in power generation anywhere from about 100 kW to 5 MW, by way of non-limiting example only. Due to potential standardization, production cost and delivery schedules may also be significantly reduced.

Referring again to FIG. 1, an illustration of an exemplary embodiment of the present invention as a two-stage gasifier 5 is shown. Gasifier 5 generally includes a first-stage gasifier 20 and an authothermal reformer 90.

### First-Stage Gasification

Gasifier 20 may take the form of a rotary kiln reactor system. Different types of biomass, either as single feed or in combination, may be fed into the first-stage gasifier 20 through feed hopper 10, which may be further equipped with a weight screw feeder at the bottom. Solid biomass feed may be fed in an opposite direction or countercurrent to gas flow. Oxygen and reactant gas containing a variety of gases, such as gases that may not react with oxygen, for example, steam and carbon dioxide may be distributed within first-stage gasifier 20 using gas distributor 30.

Gas distributor 30 may include one or more stationary pipes supported by stationary end plates, which may serve as a housing for gas distribution piping. This stationary pipe housing may be purged with, for example, air, steam or water, to help maintain its integrity within the hostile environment of the gasifier. Gas distribution pipes, housed within the stationary pipe, may terminate at an outer wall of the stationary pipe so as to deliver oxygen-bearing gases along the length of the gasifier in a prescribed manner. The gas distribution pipes may also deliver oxygen-bearing gases into a gas distributor constructed on the outer surface of the stationary pipe. In this example, the outer surface gas distributor may be of any size and shape, so long as the distribution of reactant gases remains regulated along the entire length of the gasifier.

According to an aspect of the present invention distributor 30 may be used to deliver different amounts of reactant gas and oxygen to differing portions of the gasifier 20, such that corresponding portions of gasifier 20 perform different functions.

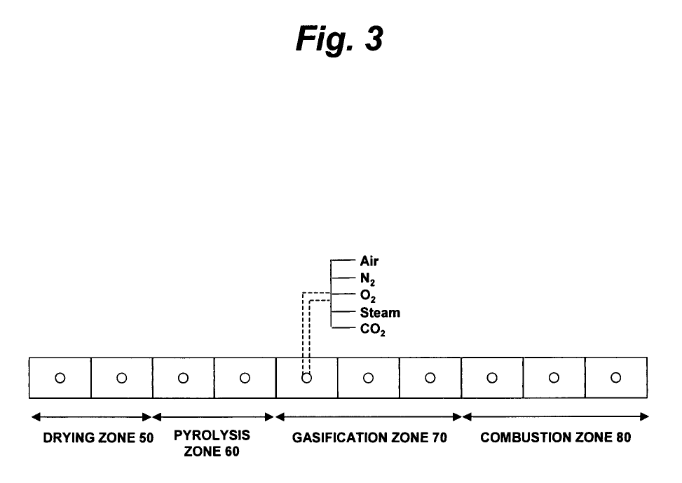

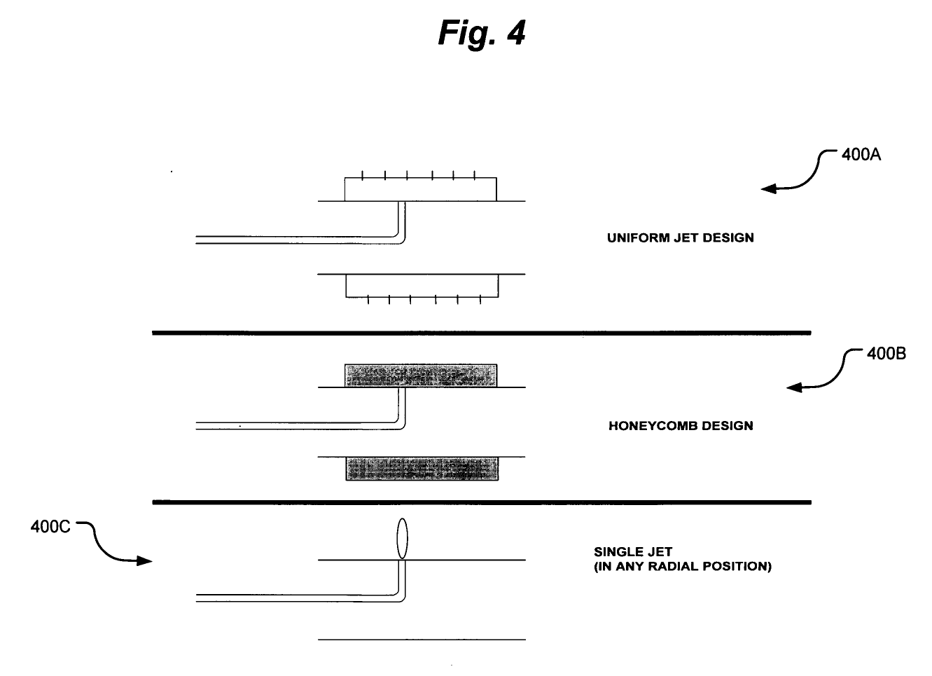

Referring now also to FIG. 3, there is shown an exemplary gas distributor 30. Distributor 30 may include multiple, distinct portions each corresponding to a reaction region within first-stage gasifier 20. These regions may include drying region 50, pyrolysis region 60, gasification region 70 and combustion region 80. Gas distribution within these regions may be, for example, of a uniform jet configuration, honeycomb configuration and/or single jet configuration, which may further be in a radial position. Non-limiting illustrations of these types of gas distribution may be seen in FIG. 4. According to an aspect of the present invention, the size of the reaction regions may be varied due to the flexibility provided by distributor 30. For example, separate distribution piping and valving may be used to deliver prescribed amounts of reactant gases and oxygen to different portions of distributor 30 and hence reaction regions of the first-stage gasifier 20.

According to an aspect of the present invention, distributor 30 may be used to distribute reactant gas and oxygen into first-stage gasifier 20 in a regulated manner over the length of first-stage gasifier 20, according to an equivalence ratio. The equivalence ratio may be defined as the ratio of oxygen actually consumed divided by the theoretical amount of oxygen required for complete oxidation to take place. Through manipulation of this ratio, temperatures and reactions that occur along the length of first-stage gasifier 20 may be manipulated and moderated so as to be under designed control. Exemplary equivalence ratios corresponding to reactions occurring during biomass gasification are shown in Table 2.

TABLE 2
EFFECT OF EQUIVALENCE RATIO ON REACTIONS

| REACTION | EQUIVALENCE RATIO |
|---|---|
| Drying | 0.0-0.0 |
| Pyrolysis | 0.0-0.1 |
| Gasification | 0.1-0.4 |
| Combustion | 1.0-1.3 |

By way of non-limiting example only, gas distributor 30 may be used to provide air, nitrogen, oxygen, steam and/or carbon dioxide within first-stage gasifier 20. Flows of the reactant gas and oxygen may provide an equivalence ratio of about 0.0 in region 50 to provide for drying of biomass provided by hopper 10. Flows of reactant gas and oxygen may provide an equivalence ratio of between about 0.0-0.1 in region 60 to provide pyrolysis functionality on the resultant of region 50. Flows of reactant gas and oxygen may provide an equivalence ratio of between about 0.1-0.4 in region 70 to provide gasification functionality on the resultant of region 60. Finally, flows of reactant gas and oxygen may provide an equivalence ratio of between about 1.0-1.3 in region 80 to provide combustion functionality on the resultant of region 70. That is, larger flows of reactant gas, as well as larger proportions of oxygen, may be maintained at or near ash discharge 40 as compared to feed hopper 10 in order to generate a heating profile well suited to convert biomass into synthesis gas.

As set forth, the reactant gas, or gasification medium, as found or produced in gasifier 20, may be either a single gas or combination of gases, such gases including, for example, nitrogen, steam, carbon dioxide, and any other gas that may not react with oxygen. Moisture contained in the biomass may also be utilized for gasification.

Except for combustion zone 80, substoichiometric oxygen may be maintained in the other zones. Oxygen-bearing gases may be distributed as needed to control the reaction temperatures in these zones. Overall, temperature ranges within this first stage gasifier 20 may be maintained between about 800° F. to about 2500° F. and at a pressure close to atmospheric pressure, for example. Additionally, pressures within the gasification system may also range from about −1 psig to +1500 psig.

Hot gas may flow countercurrent to the solid biomass flow in first-stage gasifier 20 according to an aspect of the present invention, such that hot gases from region 80 may also dry, pyrolize and gasify biomass provided by hopper 10. That is, oxygen-bearing gas may be introduced into first-stage gasifier 20 in a direction that is countercurrent to biomass flow in order to extract moisture, as well as to react with organic components of biomass introduced using hopper 10. Combustion zone 80 may ensure the nearly complete reaction of all organics present in the biomass residue and to minimize any loss of residual carbon within the ash. Because of countercurrent flow and temperature gradients of first-stage gasifier 20, the gas generated in this embodiment may consist primarily of, for example, high and low molecular weight hydrocarbons, hydrogen, carbon monoxide, carbon dioxide, steam and water.

Solids discharged from first-stage gasifier 20 may contain primarily ash. Ash produced may be extracted from gasifier 20 in either solid form or molten form. This may be controlled by manipulating the temperature in combustion zone 80, which is within the proximity of ash discharge assembly 40 of the gasification system, dependently on the fusion temperature of the biomass inorganic residue. This ash may contain most of the mineral matter found in the original biomass, and thus may be well suited to nurture soils or other growing materials lacking these minerals.

Sulfur, which may also be present in the biomass, may first be transformed into hydrogen sulfide in the gasifier. Adding limestone to the process may effectively capture the hydrogen sulfide as calcium sulfide, which may ultimately be converted to the stable compound calcium sulfate in combustion zone 80 prior to its discharge from first-stage gasifier 20. This may be accomplished in either stage of the gasifier, where limestone may be added for conversion of calcium carbonate to calcium oxide, prior to its reaction with gaseous sulfur species.

Referring again to FIG. 1, the higher temperature maintained at ash discharge end 40 of first gasifier 20 may be optimized for the combustion of char formed from biomass pyrolysis in upstream reactions (see reaction (3), below). Because of countercurrent flow and controlled temperature gradients of first-stage gasifier 20, gases generated may consist basically of H₂, CO, CO₂, N₂, H₂O, with light hydrocarbons, organic liquids, alcohols, oils, tars and entrained solid particulates being generally eliminated.

In first-stage gasifier 20, biomass may undergo a variety of reactions. For example, when using oxygen as the oxidant the reactions may be as follows:

(2) Pyrolysis
Biomass+Heat→CH₄+CO+CO₂+H₂O+H₂+C+CₙHₘOₚ,
where CₙHₘOₚ represents collectively a variety of organic oxides, alcohols, oils and tars.
(3) Gasification
CₙHₘOₚ+χO₂+(2n−2χ−p)H₂O+Heat→(n−y)CO₂+(2n−2χ−p+m/2−y)H₂+yCO+yH₂O
where χ is the oxygen-to-fuel molar ratio and y is the number of moles of CO₂ that reacts with H₂ to produce CO and H₂O due to the water gas shift reaction. This reaction is endothermic at low values of χ, and exothermic at high values of χ. At an intermediate value (χ₀), the heat of reaction is zero, and is referred to herein as autothermal reforming.
(4) Char Combustion
C+O₂→CO₂+Heat
(5) Carbon Steam Reaction
C+H₂O+Heat→CO+H₂
(6) Hydrogen Combustion
H₂+½O₂→H₂O+Heat
(7) Reverse Boudard Reaction
C+CO₂+Heat→2CO
(8) Water-Gas Shift
CO+H₂O [symbol] CO₂+H₂+Heat

The reaction of pyrolysis may be one of reduction of the organic material when in the presence of heat under endothermic conditions. When the material being processed is biomass, the basic chemical reaction of pyrolysis may be the chemical reduction of biomass to CH₄, H₂, H₂O, CO, CO₂, char and a variety of organic oxides, alcohols, oils, and tars, which may be collectively represented as CₙHₘOₚ.

Different temperatures during pyrolysis may tend to produce different compounds as well as variable amounts of such compounds. For example, low pyrolysis temperatures and long retention times may tend to produce large quantities of, among other things, oils, tars, chars, organic liquids and carbon monoxide. Moderate pyrolysis temperatures and moderate retention times may tend to produce large quantities of tars and oils with lesser amounts of elemental carbon char, while high pyrolysis temperatures with short retention times may tend to produce increased quantities of CO, CO₂, CH₄, and H₂, with lesser amounts of organic liquids, alcohols, tars, oils and solid carbon char (charcoal).

### EXAMPLE 1

On a dry basis by weight, cellulosic type compounds compose about 62% of wood, 43% of bagasse and 35% of rice husk. When these compounds undergo pyrolysis, the following chemical reaction takes place:

$${{( {C}_{6} {H}_{10} {O}_{5} )}_{n}}_{Cellulosic Cqd .} + Heat ⟶ {{C}_{6} {H}_{8} O}_{Pyrolysis Oil} + {C}_{Charcoal} + {{H}_{2} O}_{Steam} + {{H}_{2}}_{Hydrogen} + {{CH}_{4}}_{Methane} + {{C}_{2} {H}_{4}}_{Ethylene} + {CO}_{Carbon Monoxide} + {{CO}_{2}}_{Carbon Dioxide} + {RCOOH}_{Acids} + {ROH}_{Alcohols} + Tars \qquad ( 9 )$$

where R can be H, CH₃, C₂H₅ or C₃H₇.

Only a limited amount of the oxygen supplied (partial oxidation) may be used to generate heat for the endothermic gasification reactions. For example, during gasification, the complex structure of CₙHₘOₚ produced by pyrolysis may be reduced to a simpler gaseous component, as seen in reaction (2) above. Further, char produced by pyrolysis may be combusted within the gasifier to produce process heat, as seen in reaction (3) above. No solids recycling may be needed within the gasifier.

Through the selection of particular operating conditions, various gas compositions may be produced or obtained. For example, operation at a lower temperature, such as 730° C. (or 1350° F.), may favor the production of a methane rich fuel gas, whereas high temperature operation, such as at 982° C. (or 1800° F.), may favor the production of a gas rich in hydrogen and carbon monoxide.

### EXAMPLE 2

For gasification of cellulosic type compounds such as C₆H₁₀O₅ (i.e. n=6, m=10, p=5) with an equivalence ratio of 0.167 i.e. χ=1 in equation (3), the gasification reaction with heat can be represented as follows:
C₆H₁₀O₅+O₂+(12−2−5)H₂O→(6−y)CO₂+(12−2−5+5−y)H₂+yCO+yH₂O (10)
or
C₆H₁₀O₅+O₂+5H₂O→(6−y)CO₂+(10−y)H₂+yCO+yH₂O (11)
when y=0
C₆H₁₀O₅+O₂+5H₂O→6CO₂+10H₂ (12)
when y=3
C₆H₁₀O₅+O₂+2H₂O→3CO₂+7H₂+3CO (13)
when y=5
C₆H₁₀O₅+O₂→CO₂+5H₂+5CO (14)
when y=6
C₆H₁₀O₅+O₂→4H₂+6CO+H₂O (15)

When χ equals 1 (or the equivalence ratio equals 0.167), the product gas from C₆H₁₀O₅ due to the gasification step alone will have a composition of:

TABLE 3
PRODUCT GAS COMPOSITION FROM GASIFICATION OF
CELLULOSIC TYPE COMPOUNDS

| | MOL %, DRY, χ = 1 | | |
|---|---|---|---|
| PRODUCT GAS | y = O | y = 5 | y = 6 |
| H₂ | 62.5 | 45.5 | 36.4 |
| CO | — | 45.5 | 54.5 |
| CO₂ | 37.5 | 9.0 | — |
| TOTAL | 100.0 | 100.0 | 100.0 |

### EXAMPLE 3

In general, biomass has lower heating values than fossil fuels such as bituminous coal, oil or natural gas. It is beneficial to extend the range of compatible feedstocks such as municipal solid waste, used tires, waste oils, etc. In this example, a waste oil (CH_{11.4}H_{2.8}) is fed together with the biomass to the two-stage gasifier. The gasification with heat of the waste oil, i.e. n=11.4, m=22.8, p=0, with oxygen and steam with an equivalence ratio of 0.25, i.e. χ32 5.7, the following equations may apply:
C_{11.4}H_{22.8}+5.7O₂+11.4H₂O→11.4CO₂+22.8H₂ (when y=0) (16)
C_{11.4}H_{22.8}+5.7O₂+5.7H₂O→5.7CO₂+17.1H₂+5.7CO (when y=5.7) (17)
C_{11.4}H_{22.8}+5.7O₂→11.4H₂+11.4CO (when y=11.4) (18)

The product gas from the gasification of waste oil may have a composition according to Table 4 below:

TABLE 4
PRODUCT GAS COMPOSITION FROM
GASIFICATION OF WASTE OILS

| | Mol %, dry | | |
|---|---|---|---|
| Product Gas | y = 0 | y = 5.7 | y = 11.4 |
| H₂ | 66.7 | 60.0 | 50.0 |
| CO | — | 20.0 | 50.0 |
| CO₂ | 33.3 | 20.0 | — |
| TOTAL | 100.0 | 100.0 | 100.0 |

Both the carbon steam and reverse Boudard reactions as described above are highly endothermic. The rates, as well as the occurrence, of these reactions are also temperature dependent. While these rates are quite low when at temperatures less than about 1500° F., the reaction rates increase rapidly with temperatures greater than about 1500° F. For example, the reverse Boudard reaction typically occurs under high temperature and oxygen deficient conditions. Additionally, char and hydrogen combustion reactions provide the heat necessary for other aspects of the gasification process.

### EXAMPLE 4

The charcoal formed during the pyrolysis process of biomass as shown in Example 1 tends to be removed from the first-stage gasifier with the inert solids (ash) unless it is further oxidized by means of partial or complete oxidation as follows:
2C+O2₋2CO+Heat (19)
C+O₂→CO₂+Heat (4)
2CO+O₂→2CO₂+Heat (20)
C+CO₂+Heat→2CO (6)
C+2H₂+Heat→CH₄ (21)
C+H₂O+Heat→CO+H₂ (22)

### Second-Stage Gasification

Referring again to FIG. 1, second-stage gasifier 90 may take the form of a tubular, stationary, horizontal or vertical vessel fitted with a gas distributor 100, which may be similar to distributor 30 of first-stage gasifier 20. Alternatively, it may provide for a single reaction region, rather than multiple regions as are found in first-stage gasifier 20. The introduction of a controlled amount of oxidant may permit temperature variations in second-stage gasifier 90 to carry out reactions well suited to break up tars and oils that may escape first-stage gasifier 20. Second-stage gasifier 90 may also permit reactions well suited to extract unreacted carbon that may escape from first-stage gasifier 20. While the gases may flow in a direction countercurrent to solid biomass flow in first-stage gasifier 20, the gases produced in first-stage gasifier 20 may flow into second-stage gasifier 90 concurrently.

Further still, second-stage gasifier 90 may enable calcination reaction for the conversion of calcium carbonate to calcium oxide, prior to its reaction with gaseous sulfur species, by providing heat generated from partial oxidation of gases produced in first-stage gasifier 20 and passing through second stage gasifier 90. Second-stage gasifier 90 may also allow for the manipulation of gas compositions through temperature control, as well as through further reaction with steam, oxygen and carbon dioxide.

In contrast to first-stage gasifier 20, in second-stage gasifier 90 a larger quantity and/or larger concentration of oxygen may be introduced into the front end thereof to raise the temperature of the incoming gases and promote reactions that may break chains of high molecular weight hydrocarbons, and subsequently produce particular gases or combinations of gases, such as those containing primarily hydrogen, carbon monoxide, carbon dioxide and steam. Additional steam may be introduced into second-stage gasifier 90 through distributor 100 to produce more hydrogen. Temperature ranges in second stage gasifier 90 may be maintained between about 1500° F. and about 2500° F., for example. An auxiliary burner may also be provided, at the lower part of second-stage gasifier 90 in the case of a vertical configuration, for start-up and to sustain suitable operating temperature throughout the gasification processes.

In second-stage gasifier 90, autothermal reforming reaction combines the heat effects of partial oxidation and steam reforming reactions by feeding oxygen and a reactant gas comprising steam and carbon dioxide into first-stage gasifier 20 gas product. Oxygen-bearing gas fed into second-stage gasifier 90 may flow concurrently with first-stage gasifier 20 gas product in second-stage gasifier 90. The initial oxidation reactions may result in heat generation and high temperatures. The heat generated from oxidation reactions may be used to steam reform the remaining light hydrocarbons, organic oxides, alcohols, oils, tars and entrain particulates coming from first-stage gasifier 20 off gas with steam generated from first-stage gasifier 20 and additional oxidant feed. The synthesis gas produced from two-stage gasifier 90 may be essentially free of carbon chars, oils and tars.

A mixture of moisture, organic oxides, alcohols, oils, tars, entrained particulate matter and other trace gases may be reacted with oxygen-bearing gases in second-stage gasifier 90 to produce a mixture of gases, such as hydrogen, carbon monoxide, carbon dioxide, steam and nitrogen, for example. Autothermal reforming of the remaining light hydrocarbons, organic oxides, alcohols, oils, tars and entrained solid particulates, which have been collectively referred to herein as CₙHₘOₚ, may be represented by the following equation in which oxygen may be used as an oxidant:
CₙHₘOₚ+χO₂+(2n−2χ−p)H₂O→(n−y)CO₂+(2n−2χ−p+m/2−y)H₂+yCO+yH₂O (23)
where χ is the oxygen-to-fuel molar ratio and y is the number of moles of CO₂ that reacts with H₂ to produce CO and H₂O, due to the water-gas shift reaction. The χ ratio is an important operating parameter because it determines, among other things, the amount of water required to convert carbon to carbon oxides, the hydrogen yield (moles), the concentration (mol %) of hydrogen in the product gas, and the heat of reaction. This reaction may be endothermic at low values of χ, and exothermic at high values of χ. At an intermediate value (χ₀), the heat of reaction is zero.

### EXAMPLE 5

By way of further, non-limiting example only, for the autothermal reforming of pyrolysis oil, C₆H₈O (i.e. n=6, m=8, p=1) produced from the pyrolysis of cellulosic type compounds in Example 1 with the same equivalence ratio of 0.167 as used in Example 2, i.e. χ=1.2525 in equation (23). The autothermal reforming reaction of the pyrolysis oil can be represented as follows:
C₆H₈O+1.2525O₂+(12−2.5050−1)H₂O→(6−y)CO₂+(12−2.5050−1−4−y)_H₂+yCO+yH₂O (24)
or
C₆H₈O+1.2525O₂+8.4950H₂O→(6−y)CO₂+(12.4950−y)H₂+yCO+yH₂O (25)
when y=0
C₆H₈O+1.2525O₂+8.4950H₂O→(6−y)CO₂+12.4950H₂ (26)
when y=3
C₆H₈O+1.2525O₂+8.4950H₂O→3CO₂+9.4950H₂+3CO+3H₂O (27)
when y=5
C₆H₈O+1.2525O₂+8.4950H₂O→CO₂+7.4950H₂+5CO+5H₂O (28)
when y=6
C₆H₈O+1.2525O₂+8.4950H₂O→6.4950H₂+6CO+6H₂O (29)

When χ equals 1.2525 (or the equivalence ratio equals 0.167), the product gas from C₆H₈O (pyrolysis oil) due to autothermal reforming step alone will have a composition of:

TABLE 5
PRODUCT GAS COMPOSITON FROM AUTOTHERMAL
REFORMING OF PYROLYSIS OIL

| | Mol %, dry, χ = 1.2525 | | |
|---|---|---|---|
| Product Gas | y = 0 | y = 5 | y = 6 |
| H₂ | 67.6 | 55.5 | 52.0 |
| CO | — | 37.1 | 48.0 |
| CO₂ | 32.4 | 7.4 | — |
| TOTAL | 100.0 | 100.0 | 100.0 |

### Gasifier System

Referring again to FIG. 1, product gas emanating from second-stage gasifier 90 of gasifier 5 may be cleaned and utilized by a number of methods. For example, hot product gas may be passed through a hot gas filter to remove particulate from the product gas. After filtering, the gas may be utilized by an engine or fuel cell to produce electricity. The gas can also be used as a chemical block to produce chemicals or transportable fuels such as methanol, ethanol and dimethyl ether. Such a filter may operate at a temperature which is similar to the temperature of the gases exiting second-stage gasifier 90.

Alternatively, or in addition to such a use, gas exiting second-stage gasifier 90 may first be cooled by an indirect means, such as using a heat exchanger to reduce its temperature to about 100° F. above its dew point and then passed through a filter. Both methods of product gas cleanup may be used, in any order, if desired. In this second method, the hot gas may be quenched with water or steam to reduce its temperature. Alternatively, heat may be extracted through indirect contact with other fluids to accomplish the same resulting lower temperatures.

The temperature after quenching may be maintained at least about 100° F. above the gas dew point to avoid condensation of water in downstream equipment. The cooled gas may be passed through the filter to remove the particulates. After filtering, the gas may, again, be utilized by a variety of fuel requiring items or processes as described above.

Additionally, the cooled gas described above, after filtering, may be treated by a water-gas-shift catalytic reactor in order to adjust the gas composition, possibly making it richer in hydrogen or to match a predetermined hydrogen to carbon monoxide ratio.

Further, in both of the above exemplary methods, moisture content of the gas may be removed by condensation, and carbon dioxide content may be removed by absorption with a chemical to produce a gas that may be primarily hydrogen.

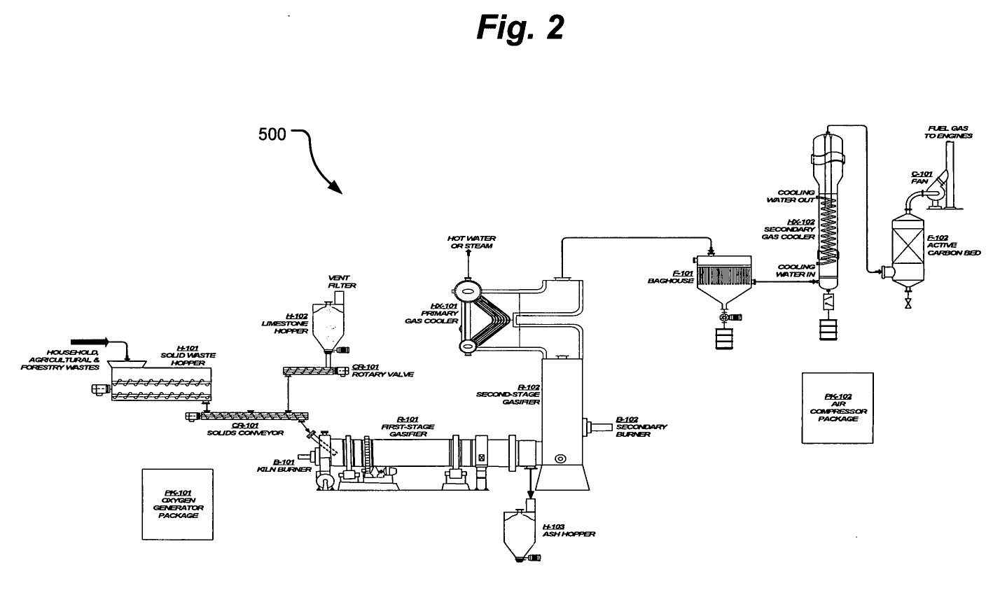

Referring now also to FIG. 2, there is shown a system 500 according to an aspect of the present invention. System 500 generally includes a solid waste hopper H-101 that may serve as hopper 10. Feed from hopper H-101 may be gathered via a solids conveyer CR-101, that also gathers limestone from a limestone hopper H-102. Conveyor CR-101 feeds a gasifier R-101 that may serve as first-stage gasifier 20. Gasifier R-101 may take the form of a kiln burner B-101 and output ash to an ash hopper H-103, that may serve as ash hopper 40. Gasifier R-101 feeds a gasifier R-102, that may serve as second-stage gasifier 90. Gasifier R-102 may include a burner B-102 near where output from gasifier R-101 is introduced. A primary gas cooler HX-101 may be used to cool output gases from gasifier R-102 to about 300° F., for example. The cooled gases may be provided to a baghouse F-101 for filtering, for example. The filtered gas may be further cooled using a secondary cooler HX-102 and fed through an actove carbon bed F-102 to remove remaining organic materials, for example. Finally the gas may be packaged using a fan C-101 for example, to provide fuel for one or more engines, by way of non-limiting example only. Heat and steam from the cooling stages may be used in conventional manners, either within the system or for other energy production or heating purposes, all by way of non-limiting example.

Those of ordinary skill in the art may recognize that many modifications and variations of the present invention may be implemented without departing from the spirit or scope of the invention. Thus, it is intended that the present invention covers the modifications and variations of this invention provided they come within the scope of the appended claims and their equivalents.

1. A waste-to-synthesis gas system comprising:
a first gasifier for receiving biomass;
a gas distributor for delivering reactant gas and oxygen into said first gasifier in a countercurrent direction to said biomass flow and to define a plurality of reaction regions comprising a drying region, a pyrolisis region, a gasification region and a combustion region; and,
a second gasifier for receiving gases from said plurality of regions of said first gasifier and extracting carbon chars, oils and tars therefrom.

2. The system of claim 1, wherein said first gasifier comprises a rotary kiln reactor.

3. The system of claim 2, wherein said second gasifier comprises an autothermal reformer.

4. The system of claim 3, wherein said gas distributor comprises a housing and piping for delivering reactant gas to said plurality of regions in a prescribed manner.

5. The system of claim 4, wherein said prescribed manner is dependent upon a desired ratio of oxygen actually consumed divided by the theoretical amount of oxygen needed for complete oxidation.

6. The system of claim 3, comprising means for feeding calcium carbonate into at least one of said gasifiers.

7. The system of claim 6, wherein said autothermal reformer converts said calcium carbonate into calcium oxide prior to its reaction with a gaseous sulfur species and oxygen.

8. The system of claim 1, further comprising an ash hopper for receiving ash from said first gasifier.

9. The system of claim 8, wherein said ash comprises minerals from said biomass and is suitable for use as fertilizer.

10. The system of claim 2, wherein said distributor comprises a stationary pipe.

11. The system of claim 10, wherein said distributor delivers a gas mixture comprising one or more of oxygen, mixtures of oxygen and nitrogen including air, mixtures of oxygen and steam, mixtures of oxygen, nitrogen, steam and carbon dioxide and mixtures including at least one gas that do not react with oxygen.

12. The system of claim 3, wherein said second gasifier receives a mixture of moisture, organic oxides, alcohols, oils, tars, other gases and entrained particulate matter from said first gasifier, which are reacted with oxygen-bearing gases to produce a mixture of gases comprising hydrogen, carbon monoxide, carbon dioxide, steam and nitrogen.

13. The system of claim 12, wherein all of said gases are flowing concurrent.

14. The system of claim 4, further comprising means for purging said housing with at least one material selected from the group consisting of: air, steam and water.

15. The system of claim 4, further comprising valving coupled to said piping for reconfiguring said regions.

16. A process for converting biomass waste to synthesis gas comprising:
feeding said biomass waster into a first gasifier in a first direction, said first gasifier comprising a drying region, a pyrolisis region, a gasification region and a combustion region;
delivering reactant gas and oxygen into said first gasifier in a second direction countercurrent to said first direction and in a prescribed manner to said reaction regions; and,
providing gases from said reaction regions to a second gasifier suitable for extracting carbon chars, oils and tars therefrom.

17. The process of claim 16, wherein said first gasifier comprises a rotary kiln reactor.

18. The process of claim 17, wherein said second gasifier comprises an autothermal reformer.

19. The process of claim 18, wherein said delivering reactant gas comprises delivering reactant gas to said plurality of regions in a prescribed manner.

20. The process of claim 19, wherein said prescribed manner is dependent upon a desired ratio of oxygen actually consumed divided by the theoretical amount of oxygen needed for complete oxidation.

21. The process of claim 16, further comprising feeding calcium carbonate into at least one of said gasifiers.

22. The process of claim 21, wherein said second gasifier is an autothermal reformer and converts said calcium carbonate into calcium oxide prior to its reaction with a gaseous sulfur species and oxygen.

23. The process of claim 16, further comprising collecting ash from said first gasifier.

24. The process of claim 23, wherein said ash comprises minerals from said biomass waste and is suitable for use as fertilizer.

25. The process of claim 2, wherein said distributing oxygen and reactant gas comprises using a stationary pipe.

26. The process of claim 25, wherein said oxygen and reactant gas comprise one or more of oxygen, mixtures of oxygen and nitrogen including air, mixtures of oxygen and steam, mixtures of oxygen, nitrogen, steam and carbon dioxide and mixtures including at least one gas that do not react with oxygen.

27. The process of claim 16, wherein said second gasifier receives a mixture of moisture, organic oxides, alcohols, oils, tars, other gases and entrained particulate matter from said first gasifier, and reacts said mixture with oxygen-bearing gases to produce a mixture of gases comprising hydrogen, carbon monoxide, carbon dioxide, steam and nitrogen.

28. The process of claim 27, wherein all of said gases flow concurrent in said second gasifier.

29. The process of claim 25, further comprising means for purging said pipe with at least one material selected from the group consisting of: air, steam and water.
